(19) United States
(12) Patent Application Publication
(10) Pub. No.: US 2024/0005531 A1
(43) Pub. Date: Jan. 4, 2024

(54) Method For Change Detection

(71) Applicant: SI Analytics Co., Ltd., Daejeon (KR)

(72) Inventor: Minseok SEO, Daejeon (KR)

(73) Assignee: SI Analytics Co., Ltd., Daejeon (KR)

(21) Appl. No.: 18/343,065

(22) Filed: Jun. 28, 2023

(30) Foreign Application Priority Data
Jun. 29, 2022 (KR) 10-2022-0079913

(51) Int. Cl. G06T 7/246

(52) U.S. Cl. CPC G06T 7/248; G06T 2207/20084

(57) ABSTRACT

According to an exemplary embodiment of the present disclosure, a method of detecting a change by using a pre-trained artificial neural network model. In particular, according to the present disclosure, a computing device obtains reference image data and comparison target image data corresponding to the reference image data, and detects a change in the comparison target image data relative to the reference image data by using a pre-trained artificial neural network model, and the pre-trained artificial neural network model corresponds to an artificial neural network model pre-trained based on a pair of image data generated based on original image data at a single time point.

### CROSS-REFERENCE TO RELATED APPLICATIONS

This application claims priority to and the benefit of Korean Patent Application No. 10-2022-00-79913 filed in the Korean Intellectual Property Office on Jun. 29, 2022, the entire contents of which are incorporated herein by reference.

### TECHNICAL FIELD

The present disclosure relates to a method of detecting a change between images, and particularly, to a method of detecting a change between images by using an artificial neural network model pre-trained based on a pair of image data generated based on original image data at a single time point.

### BACKGROUND ART

It is well known to those skilled in the art to use a pair of images of the same geographic location taken at different time points as training data in order to build a change detection model using an artificial neural network. However, collecting a pair of images of the same geographic location taken at different time points to train a model is time-consuming and expensive, so building a large enough dataset to train a model is a very important task. If this problem cannot be solved, an artificial neural network model for change detection that is trained with a dataset that is not large enough to be used as training data is more likely to suffer from overfitting.

Therefore, there is a need in the art for a method of appropriately detecting a change without causing overfitting by training a change detection model by obtaining a pair of image data taken at different time points for efficiently training the change detection model, without directly collecting image data of the same geographical location taken at different time points.

### SUMMARY OF THE INVENTION

The present disclosure has been conceived in response to the foregoing background art, and aims to detect a change in comparison target image data relative to original image data by using an artificial neural network model pre-trained based on a pair of image data generated based on the original image data at a single time point.

An exemplary embodiment of the present disclosure provides a method performed by a computing device for detecting a change. The method includes: obtaining reference image data and comparison target image data corresponding to the reference image data; and detecting a change in the comparison target image data relative to the reference image data by using a pre-trained artificial neural network model, in which the pre-trained artificial neural network model corresponds to a model pre-trained based on a pair of image data generated based on original image data at a single time point.

In an alternative exemplary embodiment, the pre-trained artificial neural network model may correspond to an artificial neural network model pre-trained based on operations of: obtaining the original image data and a label corresponding to the original image data; generating transformed image data based on the original image data; generating a ground truth label based on the label of the original image data and a label of the transformed image data; and training the artificial neural network model to output a change between the original image data and the transformed image data based on the ground truth label.

In the alternative exemplary embodiment, the generating of the transformed image data based on the original image data may include generating the transformed image data based on rotating or inverting a region of at least a portion of the original image data.

In the alternative exemplary embodiment, the generating of the transformed image data based on the original image data may include generating the transformed image data based on removing one or more objects included in the original image data.

In the alternative exemplary embodiment, the generating of the transformed image data based on the original image data may include generating the transformed image data based on synthesizing one or more objects onto the original image data.

In the alternative exemplary embodiment, the transformed image data may be generated based on Fourier blending.

Another exemplary embodiment of the present disclosure provides a method of training a change detection model. The method may include: obtaining original image data at a single time point and a label corresponding to the original image data; generating transformed image data based on the original image data; generating a ground truth label based on the label of the original image data and a label of the transformed image data; inputting a data pair consisting of the original image data and the transformed image data into the change detection model; and training the change detection model to output a change between the original image data and the transformed image data based on the ground truth label.

Another exemplary embodiment of the present disclosure provides a computer program for detecting a change. The program includes operations of: obtaining reference image data and comparison target image data corresponding to the reference image data; and detecting a change in the comparison target image data relative to the reference image data by using a pre-trained artificial neural network model, in which the pre-trained artificial neural network model corresponds to a model pre-trained based on a pair of image data generated based on original image data at a single time point.

Another exemplary embodiment of the present disclosure provides a computing device for detecting a change. The computing device includes: a processor including one or more cores; a network unit for receiving one or more data; and a memory, and the processor is configured to: obtain reference image data and comparison target image data corresponding to the reference image data; and detect a change in the comparison target image data relative to the reference image data by using a pre-trained artificial neural network model, and the pre-trained artificial neural network model corresponds to a model pre-trained based on a pair of image data generated based on original image data at a single time point.

An artificial neural network model trained in the method of the present disclosure is capable of detecting a change in a comparison target image relative to a reference image by receiving a pair of images as input and presenting an analysis result to a user.

### BRIEF DESCRIPTION OF THE DRAWINGS

The accompanying drawings for use in the description of the exemplary embodiments of the present disclosure are only some of the exemplary embodiments of the present disclosure, and other drawings may be obtained based on the drawings by a person of ordinary skill in the art to which the present disclosure belongs (hereinafter referred to as “a person skilled in the art”) without an effort to arrive at a novel invention.

FIG. 1 is a block diagram of a computing device for detecting a change according to an exemplary embodiment of the present disclosure.

FIG. 2 is a schematic diagram illustrating a network function according to the exemplary embodiment of the present disclosure.

FIG. 3 is a conceptual diagram illustrating a process of detecting, by a change detection model, a change according to the exemplary embodiment of the present disclosure.

FIG. 4 is a conceptual diagram illustrating a process of generating transformed image data and defining a label based on rotating or inverting a region of at least a portion of original image data according to the exemplary embodiment of the present disclosure.

FIG. 5 is a conceptual diagram illustrating a process of generating transformed image data and defining a label based on removing one or more objects included in original image data according to the exemplary embodiment of the present disclosure.

FIG. 6 is a conceptual diagram illustrating a process of generating the transformed image data and defining a label based on synthesizing one or more objects to original image data according to the exemplary embodiment of the present disclosure.

FIG. 7 is a simple and general schematic diagram of an example of a computing environment in which the exemplary embodiments of the present disclosure are implementable.

### DETAILED DESCRIPTION

The present disclosure discloses a method of detecting a change by receiving an original image and a comparison target image, that is, a pair of images, by using a change detection model trained with the pair of images including a transformed image generated by transforming the original image as training data.

Various exemplary embodiments are described with reference to the drawings. In the present specification, various descriptions are presented for understanding the present disclosure. However, it is obvious that the exemplary embodiments may be carried out even without a particular description.

Terms, “component”, “module”, “system”, and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

Further, a term “or” intends to mean comprehensive “or” not exclusive “or”. That is, unless otherwise specified or when it is unclear in context, “X uses A or B” intends to mean one of the natural comprehensive substitutions. That is, in the case where X uses A; X uses B; or, X uses both A and B, “X uses A or B” may apply to either of these cases. Further, a term “and/or” used in the present specification shall be understood to designate and include all of the possible combinations of one or more items among the listed relevant items.

Further, a term “include” and/or “including” shall be understood as meaning that a corresponding characteristic and/or a constituent element exists. Further, it shall be understood that a term “include” and/or “including” means that the existence or an addition of one or more other characteristics, constituent elements, and/or a group thereof is not excluded. Further, unless otherwise specified or when it is unclear that a single form is indicated in context, the singular shall be construed to generally mean “one or more” in the present specification and the claims.

Further, the term “at least one of A and B” should be interpreted to mean “the case including only A”, “the case including only B”, and “the case where A and B are combined”.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

The description about the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Therefore, the present disclosure is not limited to the exemplary embodiments presented herein. The present disclosure shall be interpreted within the broadest meaning range consistent to the principles and new characteristics presented herein.

In the present disclosure, a network function, an artificial neural network, and a neural network may be interchangeably used.

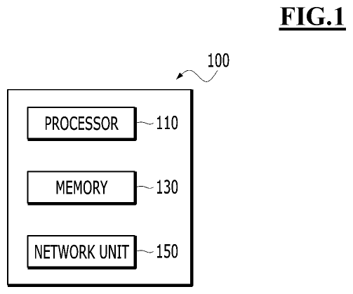

FIG. 1 is a block diagram of a computing device for detecting a change according to an exemplary embodiment of the present disclosure.

A configuration of the computing device 100 illustrated in FIG. 1 is only an example simplified and illustrated. In an exemplary embodiment of the present disclosure, the computing device 100 may include other components for performing a computing environment of the computing device 100, and only some of the disclosed components may constitute the computing device 100.

The computing device 100 may include a processor 110, a memory 130, and a network unit 150.

The processor 110 may be constituted by one or more cores, and include processors for data analysis and deep learning, such as a central processing unit (CPU), a general purpose graphics processing unit (GPGPU), a tensor processing unit (TPU), etc., of the computing device. The processor 110 may read a computer program stored in the memory 130 and process data for machine learning according to an exemplary embodiment of the present disclosure. According to an exemplary embodiment of the present disclosure, the processor 110 may perform an operation for learning the neural network. The processor 110 may perform calculations for learning the neural network, which include processing of input data for learning in deep learning (DL), extracting a feature in the input data, calculating an error, updating a weight of the neural network using backpropagation, and the like.

At least one of the CPU, the GPGPU, and the TPU of the processor 110 may process learning of the network function. For example, the CPU and the GPGPU may process the learning of the network function and data classification using the network function jointly. In addition, in an exemplary embodiment of the present disclosure, the learning of the network function and the data classification using the network function may be processed by using processors of a plurality of computing devices together. In addition, the computer program performed by the computing device according to an exemplary embodiment of the present disclosure may be a CPU, GPGPU, or TPU executable program.

According to the exemplary embodiment of the present disclosure, the processor 110 may obtain a pair of image data. For example, the processor 110 may use image data stored in the memory 130, and may use image data received through the network 15. However, the present disclosure is not limited to the illustrated image obtaining method.

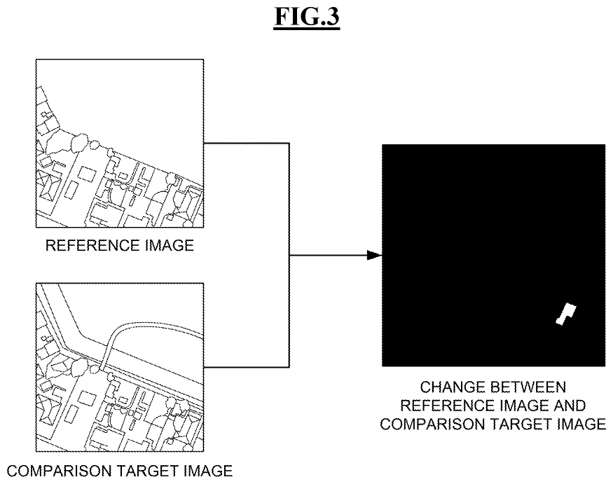

According to the exemplary embodiment of the present disclosure, the processor 110 may detect a change between two images by using a change detection model, which is an artificial neural network model for detecting a change, and present a result of the detection to a user. Referring to FIG. 3, when reference image data and comparison target image data are input to the change detection model, the change detection model may detect a change between the reference image and the comparison target image based on the reference image data. The objects that may be detected as changes may include natural landscapes, buildings, or any structure on the ground, and only a subset of these may be detected. For example, the comparison target image in FIG. 3 has new buildings and roads compared to the reference image, but the change detection model may detect only the new buildings as changes.

According to the exemplary embodiment of the present disclosure, the processor 110 may perform training of the change detection model. In this case, the training of the artificial neural network may be performed by the method of supervised learning, and a pair of image data may be used as training data.

A pair of image data for training an artificial neural network may be, but is not limited to, aerial or satellite photographs or Synthetic Aperture Radar (SAR) images taken at different time points from the same location. Image data may contain information about many kinds of objects, such as roads, buildings, and sculptures.

For training an artificial neural network model for change detection, a label may be defined for each image used for training. For example, the label corresponding to each piece of image data may be black and white image data, where objects in the image are represented in white and non-object portions are represented in black. By performing supervised learning of an artificial neural network with the change between the label corresponding to the reference image data and the label corresponding to the comparison target image data as the ground truth, the artificial neural network may learn the difference between the reference image data and the comparison target image data.

It is well known to those skilled in the art that when the performance of artificial neural network models trained through machine learning is evaluated, the larger the training data, the better the performance of the model. However, aerial or satellite photographs and SAR image data for training the artificial neural network model disclosed in the present disclosure will likely not be plentiful enough to sufficiently train the artificial neural network. Training an artificial neural network model by using training data that is not large enough may cause the overfitting problem of the model, which may lead to degradation of performance of the trained artificial neural network model.

In order to prevent overfitting of the model and increase the performance of the model, the processor 110 may include a pair of image data generated based on the original image data at a single time point as training data for the artificial neural network model for change detection. The pair of image data may include original image data and transformed image data. The transformed image data may be image data that is generated based on the original image data, but may be image data with sufficient differences from the original image data to effectively train the change detection model.

When the pair of image data consisting of the original image data and the transformed image data is included in the training data of the artificial neural network model for change detection to train the model as described above, it may be easily expected that the size of the training data is larger than the size of the training data which uses only the pair of image data consisting of the photographs taken at different time points of the same place. Therefore, the use of the pair of image data consisting of the original image data and the transformed image data as training data may have a significant effect of increasing the performance of the model.

To achieve this purpose, the processor 110 may apply various processing to the original image data to generate transformed image data, thereby generating new training data, that is, a pair of image data. A particular method of generating transformed image data will be described later.

The method of the present disclosure requires only one original image to form an image data pair, thereby saving the cost and time of building a training dataset of the same size.

Images taken at different time points of the same location actually have a limited amount of change (for example, it is extremely unlikely that a tall building will be constructed on top of a mountain and appear as a change in the image), but when the original image data is transformed to produce transformed image data, the level of change and the size, type, and number of objects to be synthesized or removed may be adjusted by the user through the processor 110. Due to these differences, the generalization performance of the model finally trained by using a data pair consisting of the original image data and the transformed image data as training data may be improved.

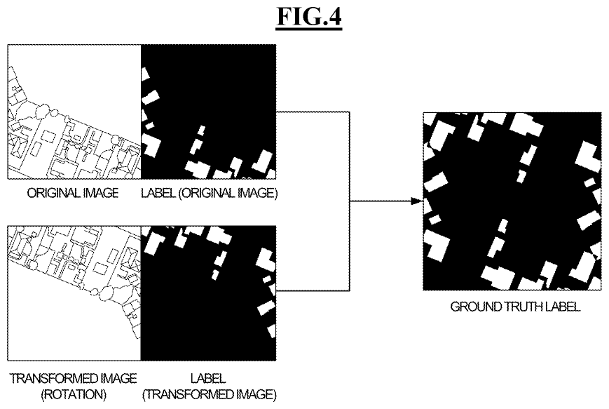

In the exemplary embodiment of the present disclosure, the processor 110 may generate transformed image data based on rotating or inverting a region of at least a portion of the original image data. The specific process of generating transformed image data based on rotation or inversion is described later with reference to FIG. 4.

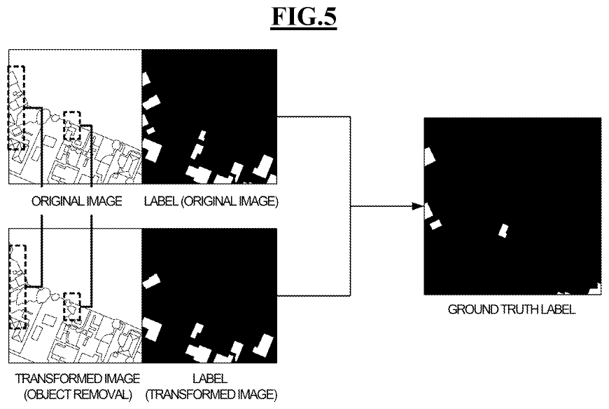

In the exemplary embodiment of the present disclosure, the processor 110 may generate transformed image data based on removing one or more objects included in the original image data. A specific process for generating transformed image data based on removing one or more objects will be described later with reference to FIG. 5.

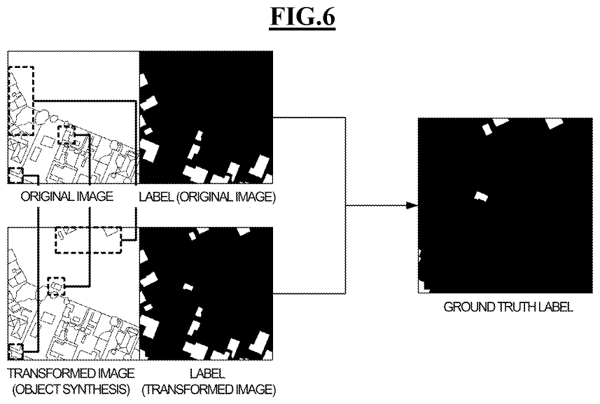

In the exemplary embodiment of the present disclosure, the processor 110 may generate transformed image data based on synthesizing one or more objects included in the original image data. A specific process for generating transformed image data based on synthesizing one or more objects is described below with reference to FIG. 6.

In the present disclosure, one transformation method may be used for one original image data, but multiple transformation methods may be used for one original image data. For example, for original image data consisting of regions A, B, C, and D, the processor 110 may generate transformed image data by rotating region A, removing a predetermined object included in region B, and synthesizing a predetermined object to region C.

In the process of generating a pair of training data consisting of the original image data and the transformed image data for training the artificial neural network model, the processor 110 may use a Fourier blending technique to generate a synthesized image.

In general, it is well known that Gaussian smoothing, Poisson blending, and Fourier blending exist as ways of synthesizing a specific object into an image. Of these, Gaussian smoothing blurs the entire image that is a synthesis target, so there is a possibility in that the change detection model is trained to perceive a portion that has not actually changed as a change. It is also well known that Poisson blending's performance is strongly affected by the size and color of objects, so that training data with the inconsistent synthesized result may be generated in training the change detection model.

As described above, Gaussian smoothing and Poisson blending are fatally flawed for training the change detection model. Therefore, in the present disclosure, a transformed image may be generated from the original image by synthesizing an object to the image through Fourier blending in order to improve the performance of the change detection model. However, there may be other methods of synthesizing objects to images other than Gaussian smoothing, Poisson blending, and Fourier blending, and the present disclosure is not limited to these exemplified synthesizing methods.

In general, to solve the overfitting problem of the artificial neural network model, a data augmentation method may be employed to increase the size of the training data. The existence of cropping, rotating, scaling, image mixing, and cut-mixing as data augmentation methods in the image processing field is widely known to those skilled in the art.

The pair of image data including the original image and the image transformed from the original image generated by the present disclosure may also utilize any data augmentation method including methods known in the art, to increase the amount of data for training.

For example, for original image A, through the method disclosed in the present disclosure, image B obtained by partially transforming image A may be generated. In this case, the pair of image data consisting of images A and B may be established as a pair of image data that may be used to train an artificial neural network model for change detection.

Image A′ may be generated by applying one or more data augmentation methods to original image A described above. Then, image B′ may be generated by applying the same data augmentation method as that of image A to transformed image B. In this case, the pair of image data consisting of images A′ and B′ may likewise be established as a pair of image data used for training an artificial neural network model for change detection. It is to be understood that the techniques for generating image B from image A described in the present disclosure and the typical data augmentation method of generating image A′ and image B′ from image A and image B, respectively, have completely different properties. Transformed image B is generated based on original image A, however, the individual image is not used for training data, but the pair of image data including image A and image B itself is used as one training data.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to several embodiments of the present disclosure may use various wired communication systems, such as a Public Switched Telephone Network (PSTN), an x Digital Subscriber Line (xDSL), a Rate Adaptive DSL (RADSL), a Multi Rate DSL (MDSL), a Very High Speed DSL (VDSL), a Universal Asymmetric DSL (UADSL), a High Bit Rate DSL (HDSL), and a local area network (LAN).

The network unit 150 presented in the present specification may use various wireless communication systems, such as Code Division Multi Access (CDMA), Time Division Multi Access (TDMA), Frequency Division Multi Access (FDMA), Orthogonal Frequency Division Multi Access (OFDMA), Single Carrier-FDMA (SC-FDMA), and other systems.

The network unit 150 presented in the present specification may use various wireless communication systems

The techniques described herein may be used not only in the networks mentioned above, but also in other networks.

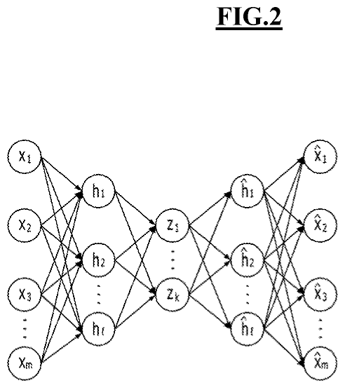

FIG. 2 is a schematic diagram illustrating a network function according to the embodiment of the present disclosure.

Throughout the present specification, the meanings of a calculation model, a nerve network, the network function, and the neural network may be interchangeably used. The neural network may be formed of a set of interconnected calculation units which are generally referred to as “nodes”. The “nodes” may also be called “neurons”. The neural network consists of one or more nodes. The nodes (or neurons) configuring the neural network may be interconnected by one or more links.

In the neural network, one or more nodes connected through the links may relatively form a relationship of an input node and an output node. The concept of the input node is relative to the concept of the output node, and a predetermined node having an output node relationship with respect to one node may have an input node relationship in a relationship with another node, and a reverse relationship is also available. As described above, the relationship between the input node and the output node may be generated based on the link. One or more output nodes may be connected to one input node through a link, and a reverse case may also be valid.

In the relationship between an input node and an output node connected through one link, a value of the output node data may be determined based on data input to the input node. Herein, a link connecting the input node and the output node may have a weight. The weight is variable, and in order for the neural network to perform a desired function, the weight may be varied by a user or an algorithm. For example, when one or more input nodes are connected to one output node by links, respectively, a value of the output node may be determined based on values input to the input nodes connected to the output node and weights set in the link corresponding to each of the input nodes.

As described above, in the neural network, one or more nodes are connected with each other through one or more links to form a relationship of an input node and an output node in the neural network. A characteristic of the neural network may be determined according to the number of nodes and links in the neural network, a correlation between the nodes and the links, and a value of the weight assigned to each of the links. For example, when there are two neural networks in which the numbers of nodes and links are the same and the weight values between the links are different, the two neural networks may be recognized to be different from each other.

The neural network may consist of a set of one or more nodes. A subset of the nodes configuring the neural network may form a layer. Some of the nodes configuring the neural network may form one layer on the basis of distances from an initial input node. For example, a set of nodes having a distance of n from an initial input node may form n layers. The distance from the initial input node may be defined by the minimum number of links, which need to be passed to reach a corresponding node from the initial input node. However, the definition of the layer is arbitrary for the description, and a degree of the layer in the neural network may be defined by a different method from the foregoing method. For example, the layers of the nodes may be defined by a distance from a final output node.

The initial input node may mean one or more nodes to which data is directly input without passing through a link in a relationship with other nodes among the nodes in the neural network. Otherwise, the initial input node may mean nodes which do not have other input nodes connected through the links in a relationship between the nodes based on the link in the neural network. Similarly, the final output node may mean one or more nodes that do not have an output node in a relationship with other nodes among the nodes in the neural network. Further, the hidden node may mean nodes configuring the neural network, not the initial input node and the final output node.

In the neural network according to the embodiment of the present disclosure, the number of nodes of the input layer may be the same as the number of nodes of the output layer, and the neural network may be in the form that the number of nodes decreases and then increases again from the input layer to the hidden layer. Further, in the neural network according to another embodiment of the present disclosure, the number of nodes of the input layer may be smaller than the number of nodes of the output layer, and the neural network may be in the form that the number of nodes decreases from the input layer to the hidden layer. Further, in the neural network according to another embodiment of the present disclosure, the number of nodes of the input layer may be larger than the number of nodes of the output layer, and the neural network may be in the form that the number of nodes increases from the input layer to the hidden layer. The neural network according to another embodiment of the present disclosure may be the neural network in the form in which the foregoing neural networks are combined.

A deep neural network (DNN) may mean the neural network including a plurality of hidden layers, in addition to an input layer and an output layer. When the DNN is used, it is possible to recognize a latent structure of data. That is, it is possible to recognize latent structures of photos, texts, videos, voice, and music (for example, what objects are in the photos, what the content and emotions of the texts are, and what the content and emotions of the voice are). The DNN may include a convolutional neural network (CNN), a recurrent neural network (RNN), an auto encoder, Generative Adversarial Networks (GAN), a Long Short-Term Memory (LSTM), a transformer, a restricted Boltzmann machine (RBM), a deep belief network (DBN), a Q network, a U network, a Siamese network, a Generative Adversarial Network (GAN), and the like. The foregoing description of the deep neural network is merely illustrative, and the present disclosure is not limited thereto.

In the embodiment of the present disclosure, the network function may include an auto encoder. The auto encoder may be one type of artificial neural network for outputting output data similar to input data. The auto encoder may include at least one hidden layer, and the odd-numbered hidden layers may be disposed between the input/output layers. The number of nodes of each layer may decrease from the number of nodes of the input layer to an intermediate layer called a bottleneck layer (encoding), and then be expanded symmetrically with the decrease from the bottleneck layer to the output layer (symmetric with the input layer). The auto encoder may perform a nonlinear dimension reduction. The number of input layers and the number of output layers may correspond to the dimensions after preprocessing of the input data. In the auto encoder structure, the number of nodes of the hidden layer included in the encoder decreases as a distance from the input layer increases. When the number of nodes of the bottleneck layer (the layer having the smallest number of nodes located between the encoder and the decoder) is too small, the sufficient amount of information may not be transmitted, so that the number of nodes of the bottleneck layer may be maintained in a specific number or more (for example, a half or more of the number of nodes of the input layer and the like).

The neural network may be trained by at least one scheme of supervised learning, unsupervised learning, semi-supervised learning, and reinforcement learning. The training of the neural network may be a process of applying knowledge for the neural network to perform a specific operation to the neural network.

The neural network may be trained in a direction of minimizing an error of an output. In the training of the neural network, training data is repeatedly input to the neural network and an error of an output of the neural network for the training data and a target is calculated, and the error of the neural network is back-propagated in a direction from an output layer to an input layer of the neural network in order to decrease the error, and a weight of each node of the neural network is updated. In the case of the supervised learning, training data labelled with a correct answer (that is, labelled training data) is used, in each training data, and in the case of the unsupervised learning, a correct answer may not be labelled to each training data. That is, for example, the training data in the supervised learning for data classification may be data, in which category is labelled to each of the training data. The labelled training data is input to the neural network and the output (category) of the neural network is compared with the label of the training data to calculate an error. For another example, in the case of the unsupervised learning related to the data classification, training data that is the input is compared with an output of the neural network, so that an error may be calculated. The calculated error is back-propagated in a reverse direction (that is, the direction from the output layer to the input layer) in the neural network, and a connection weight of each of the nodes of the layers of the neural network may be updated according to the backpropagation. A change amount of the updated connection weight of each node may be determined according to a learning rate. The calculation of the neural network for the input data and the backpropagation of the error may configure a learning epoch. The learning rate is differently applicable according to the number of times of repetition of the learning epoch of the neural network. For example, at the initial stage of the learning of the neural network, a high learning rate is used to make the neural network rapidly secure performance of a predetermined level and improve efficiency, and at the latter stage of the learning, a low learning rate is used to improve accuracy.

In the training of the neural network, the training data may be generally a subset of actual data (that is, data to be processed by using the trained neural network), and thus an error for the training data is decreased, but there may exist a learning epoch, in which an error for the actual data is increased. Overfitting is a phenomenon, in which the neural network excessively learns training data, so that an error for actual data is increased. For example, a phenomenon, in which the neural network learning a cat while seeing a yellow cat cannot recognize cats, other than a yellow cat, as cats, is a sort of overfitting. Overfitting may act as a reason of increasing an error of a machine learning algorithm. In order to prevent overfitting, various optimizing methods may be used. In order to prevent overfitting, a method of increasing training data, a regularization method, a dropout method of inactivating a part of nodes of the network during the training process, a method using a bath normalization layer, and the like may be applied.

FIG. 4 is a conceptual diagram illustrating a process of generating transformed image data and defining a label based on rotating or inverting a region of at least a portion of original image data according to the exemplary embodiment of the present disclosure.

When an original image and a label corresponding to the original image are given, the processor 110 may rotate or invert the original image to generate a transformed image, and apply the same action to the label of the original image to generate a label of the transformed image. Then, a difference between the label of the original image and the label of the transformed image may be defined as a ground truth label. The ground truth label is set to the ground truth for the difference between the original image and the transformed image to be used in the supervised learning process.

When transformed image data is generated from original image data in this way, the size and number of natural features and objects actually included in the two images are identical, so that it is possible to successfully simulate the changes in image data that would actually occur.

For example, when the vegetation in a specific region includes palm trees, it is easy to expect that the change between two images of the corresponding region taken at different time points will include newly grown palm trees or palm trees that have been cut down. When the method proposed in FIG. 4 of the present disclosure is used, the palm tree included in the original image is included in the rotated and transformed image, so the change between the original image and the transformed image includes the palm tree. As can be seen from the above examples, when a transformed image is generated by using the method of FIG. 4 of the present disclosure, it is possible to transform the image that closely approximates the changes that would actually occur, so that a model trained with the data as training data will be better able to detect changes when given real images as input.

FIG. 5 is a conceptual diagram illustrating a process of generating transformed image data and defining a label based on removing one or more objects included in original image data according to the exemplary embodiment of the present disclosure.

When an original image and a label corresponding to the original image are given, the processor 110 may generate a transformed image by a method of removing a predetermined object from the original image, and may generate a label of the transformed image by applying the same action to the label of the original image. There is no limit to the size of the objects removed, and multiple objects may be removed at the same time.

For images that capture the ground, changes in the ground are more likely to occur in the unit of an object included in the image, rather than in the unit of zone of the image. For example, over time, it's highly likely that buildings in a given region will disappear due to demolition or other reasons, but it's very unlikely that a lawn will be created in a rectangular shape in a given region. Therefore, to simulate the actual changes that might occur, the method of deleting the object included in the image data is more appropriate than the method of deleting a predetermined region of the original image and replacing the deleted region with another image.

Based on the above idea, the present disclosure removes a predetermined object from an image by removing a region including a predetermined object from the original image and overpainting the removed place based on the surrounding pixels, an inpainting process. Through the method of the present disclosure, the transformed image is generated to closely approximate the changes that would actually occur, so that a model trained with the data as training data will be better able to detect changes when given real images as input.

FIG. 6 is a conceptual diagram illustrating a process of generating the transformed image data and defining a label based on synthesizing one or more objects to original image data according to the exemplary embodiment of the present disclosure.

When an original image and a label corresponding to the original image are given, the processor 110 may generate a transformed image by a method of synthesizing a predetermined object onto the original image and applying the same action to the label of the original image to generate a label of the transformed image.

As a method for synthesizing a predetermined object, a method of copying an object from a separate image and synthesizing the object may be used, and as illustrated in FIG. 6, a method of selecting a portion of the original image, copying the selected portion, and then pasting the copied portion into a different region of the original image to generate a transformed image may be used. In this case, there is no limit to the size of the object in the original image that is to be a target of synthesis, and multiple objects may be copied and pasted into different regions of the original image at the same time.

Copying a portion of an original image includes both copying all of the pixels that the selected portion of the original image includes and pasting the copied pixels into another region, and copying only the object that the selected portion of the original image includes and pasting the copied object into another region.

When a transformed image is generated by using the method described above, the context of the image is preserved. For example, in an image obtained by photographing a mountainous area, it is very unlikely that a blue pixel that may represent the ocean will appear as a change. In the present disclosure, rather than generating a transformed image by copying a region of a completely different image and pasting the copied region into the original image, a portion of the original image is copied and pasted into the original image, which preserves the context of the image and better simulates the changes that may actually occur. Thus, through the method of the present disclosure, the transformed image is generated to closely approximate the changes that would actually occur, and thus a model trained with the data as training data will be better able to detect changes when given real images as input.

When a transformed image is generated by simply cutting out a portion of the original image and replacing the cut portion with other images, or by mixing the original image with other images, the context of the image is not preserved and includes completely different elements, so the change in the training image data pair is likely to be greater than the change that may actually occur. Therefore, it is easy to expect that the model will ultimately perform poorly when a transformed image is generated by using traditional data augmentation methods.

In the meantime, according to an embodiment of the present disclosure, a computer readable medium storing a data structure is disclosed.

The data structure may refer to organization, management, and storage of data that enable efficient access and modification of data. The data structure may refer to organization of data for solving a specific problem (for example, data search, data storage, and data modification in the shortest time). The data structure may also be defined with a physical or logical relationship between the data elements designed to support a specific data processing function. A logical relationship between data elements may include a connection relationship between user defined data elements. A physical relationship between data elements may include an actual relationship between the data elements physically stored in a computer readable storage medium (for example, a permanent storage device). In particular, the data structure may include a set of data, a relationship between data, and a function or a command applicable to data. Through the effectively designed data structure, the computing device may perform a calculation while minimally using resources of the computing device. In particular, the computing device may improve efficiency of calculation, reading, insertion, deletion, comparison, exchange, and search through the effectively designed data structure.

The data structure may be divided into a linear data structure and a non-linear data structure according to the form of the data structure. The linear data structure may be the structure in which only one data is connected after one data. The linear data structure may include a list, a stack, a queue, and a deque. The list may mean a series of dataset in which order exists internally. The list may include a linked list. The linked list may have a data structure in which data is connected in a method in which each data has a pointer and is linked in a single line. In the linked list, the pointer may include information about the connection with the next or previous data. The linked list may be expressed as a single linked list, a double linked list, and a circular linked list according to the form. The stack may have a data listing structure with limited access to data. The stack may have a linear data structure that may process (for example, insert or delete) data only at one end of the data structure. The data stored in the stack may have a data structure (Last In First Out, LIFO) in which the later the data enters, the sooner the data comes out. The queue is a data listing structure with limited access to data, and may have a data structure (First In First Out, FIFO) in which the later the data is stored, the later the data comes out, unlike the stack. The deque may have a data structure that may process data at both ends of the data structure.

The non-linear data structure may be the structure in which the plurality of data is connected after one data. The non-linear data structure may include a graph data structure. The graph data structure may be defined with a vertex and an edge, and the edge may include a line connecting two different vertexes. The graph data structure may include a tree data structure. The tree data structure may be the data structure in which a path connecting two different vertexes among the plurality of vertexes included in the tree is one. That is, the tree data structure may be the data structure in which a loop is not formed in the graph data structure.

Throughout the present specification, a calculation model, a nerve network, the network function, and the neural network may be used with the same meaning. Hereinafter, the terms of the calculation model, the nerve network, the network function, and the neural network are unified and described with a neural network. The data structure may include a neural network. Further, the data structure including the neural network may be stored in a computer readable medium. The data structure including the neural network may also include preprocessed data for processing by the neural network, data input to the neural network, a weight of the neural network, a hyper-parameter of the neural network, data obtained from the neural network, an active function associated with each node or layer of the neural network, and a loss function for training of the neural network. The data structure including the neural network may include predetermined configuration elements among the disclosed configurations. That is, the data structure including the neural network may include the entirety or a predetermined combination of pre-processed data for processing by neural network, data input to the neural network, a weight of the neural network, a hyper parameter of the neural network, data obtained from the neural network, an active function associated with each node or layer of the neural network, and a loss function for training the neural network. In addition to the foregoing configurations, the data structure including the neural network may include predetermined other information determining a characteristic of the neural network. Further, the data structure may include all type of data used or generated in a computation process of the neural network, and is not limited to the foregoing matter. The computer readable medium may include a computer readable recording medium and/or a computer readable transmission medium. The neural network may be formed of a set of interconnected calculation units which are generally referred to as “nodes”. The “nodes” may also be called “neurons.” The neural network consists of one or more nodes.

The data structure may include data input to the neural network. The data structure including the data input to the neural network may be stored in the computer readable medium. The data input to the neural network may include training data input in the training process of the neural network and/or input data input to the training completed neural network. The data input to the neural network may include data that has undergone pre-processing and/or data to be pre-processed. The pre-processing may include a data processing process for inputting data to the neural network. Accordingly, the data structure may include data to be pre-processed and data generated by the pre-processing. The foregoing data structure is merely an example, and the present disclosure is not limited thereto.

The data structure may include a weight of the neural network (in the present specification, weights and parameters may be used with the same meaning), Further, the data structure including the weight of the neural network may be stored in the computer readable medium. The neural network may include a plurality of weights. The weight is variable, and in order for the neural network to perform a desired function, the weight may be varied by a user or an algorithm. For example, when one or more input nodes are connected to one output node by links, respectively, the output node may determine a data value output from the output node based on values input to the input nodes connected to the output node and the weight set in the link corresponding to each of the input nodes. The foregoing data structure is merely an example, and the present disclosure is not limited thereto.

For a non-limited example, the weight may include a weight varied in the neural network training process and/or the weight when the training of the neural network is completed. The weight varied in the neural network training process may include a weight at a time at which a training cycle starts and/or a weight varied during a training cycle. The weight when the training of the neural network is completed may include a weight of the neural network completing the training cycle. Accordingly, the data structure including the weight of the neural network may include the data structure including the weight varied in the neural network training process and/or the weight when the training of the neural network is completed. Accordingly, it is assumed that the weight and/or a combination of the respective weights are included in the data structure including the weight of the neural network. The foregoing data structure is merely an example, and the present disclosure is not limited thereto.

The data structure including the weight of the neural network may be stored in the computer readable storage medium (for example, a memory and a hard disk) after undergoing a serialization process. The serialization may be the process of storing the data structure in the same or different computing devices and converting the data structure into a form that may be reconstructed and used later. The computing device may serialize the data structure and transceive the data through a network. The serialized data structure including the weight of the neural network may be reconstructed in the same or different computing devices through deserialization. The data structure including the weight of the neural network is not limited to the serialization. Further, the data structure including the weight of the neural network may include a data structure (for example, in the non-linear data structure, B-Tree, Trie, m-way search tree, AVL tree, and Red-Black Tree) for improving efficiency of the calculation while minimally using the resources of the computing device. The foregoing matter is merely an example, and the present disclosure is not limited thereto.

The data structure may include a hyper-parameter of the neural network. The data structure including the hyper-parameter of the neural network may be stored in the computer readable medium. The hyper-parameter may be a variable varied by a user. The hyper-parameter may include, for example, a learning rate, a cost function, the number of times of repetition of the training cycle, weight initialization (for example, setting of a range of a weight value to be weight-initialized), and the number of hidden units (for example, the number of hidden layers and the number of nodes of the hidden layer). The foregoing data structure is merely an example, and the present disclosure is not limited thereto.

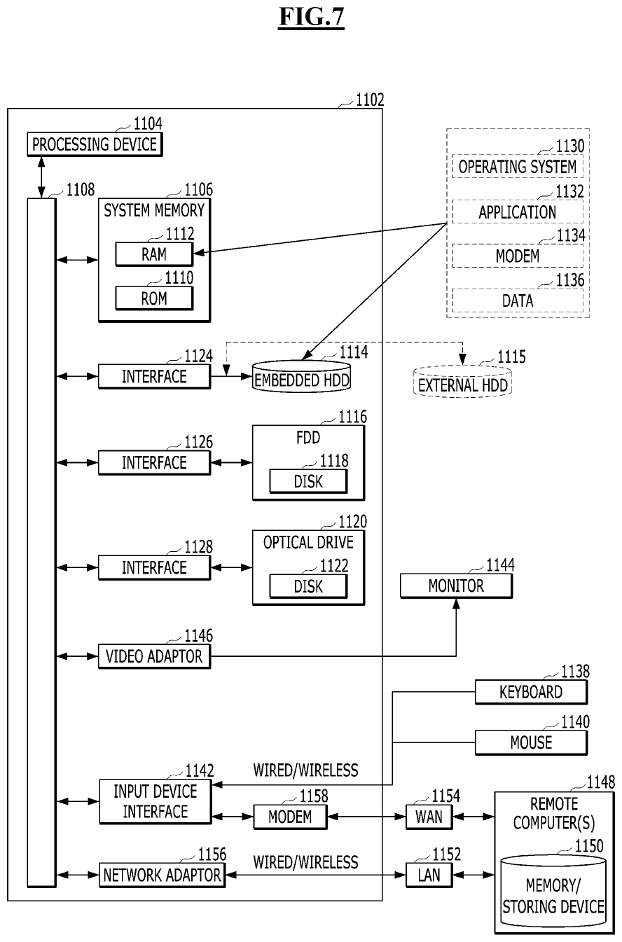

FIG. 7 is a simple and general schematic diagram illustrating an example of a computing environment in which the embodiments of the present disclosure are implementable.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will well appreciate that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transport medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a RAM, a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an EPROM, and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for exterior mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, magnetic fields or particles, optical fields or particles, or a predetermined combination thereof.

Those skilled in the art will appreciate that the various illustrative logical blocks, modules, processors, means, circuits, and algorithm operations described in relationship to the embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented embodiments is provided so as for those skilled in the art to use or carry out the present disclosure. Various modifications of the embodiments may be apparent to those skilled in the art, and general principles defined herein may be applied to other embodiments without departing from the scope of the present disclosure. Accordingly, the present disclosure is not limited to the embodiments suggested herein, and shall be interpreted within the broadest meaning range consistent to the principles and new characteristics presented herein.

What is claimed is:

1. A method performed by a computing device for detecting a change between images, the method comprising:
obtaining reference image data and comparison target image data corresponding to the reference image data; and
detecting a change in the comparison target image data relative to the reference image data by using a pre-trained artificial neural network model,
wherein the pre-trained artificial neural network model corresponds to a model pre-trained based on a pair of image data generated based on original image data at a single time point.

2. The method of claim 1, wherein the pre-trained artificial neural network model corresponds to an artificial neural network model pre-trained based on operations of:
obtaining the original image data and a label corresponding to the original image data;
generating transformed image data based on the original image data;
generating a ground truth label based on the label of the original image data and a label of the transformed image data; and
training the artificial neural network model to output a change between the original image data and the transformed image data based on the ground truth label.

3. The method of claim 2, wherein the generating of the transformed image data based on the original image data includes:
generating the transformed image data based on rotating or inverting a region of at least a portion of the original image data.

4. The method of claim 2, wherein the generating of the transformed image data based on the original image data includes:
generating the transformed image data based on removing one or more objects included in the original image data.

5. The method of claim 2, wherein the generating of the transformed image data based on the original image data includes:
generating the transformed image data based on synthesizing one or more objects onto the original image data.

6. The method of claim 5, wherein the transformed image data is generated based on Fourier blending.

7. A method of training a change detection model, the method comprising:
obtaining original image data at a single time point and a label corresponding to the original image data;
generating transformed image data based on the original image data;
generating a ground truth label based on the label of the original image data and a label of the transformed image data;
inputting a data pair consisting of the original image data and the transformed image data into the change detection model; and
training the change detection model to output a change between the original image data and the transformed image data based on the ground truth label.

8. A computing device, comprising:
a processor including one or more cores;
a network unit for receiving one or more data; and
a memory,
wherein the processor is configured to obtain reference image data and comparison target image data corresponding to the reference image data, and
detect a change in the comparison target image data relative to the reference image data by using a pre-trained artificial neural network model, and
the pre-trained artificial neural network model corresponds to a model pre-trained based on a pair of image data generated based on original image data at a single time point.
